(19) United States
(12) Patent Application Publication
(10) Pub. No.: US 2005/0223767 A1
(43) Pub. Date: Oct. 13, 2005

(54) Mobile manufacturing equipment for an organic fertilizer utilizing organic matter and its manufacturing method

(76) Inventor: Kyu Jae You, Sungnam-shi (KR)

Correspondence Address: BRUCE H. TROXELL;SUITE 1404, 5205 LEESBURG PIKE, FALLS CHURCH, VA, 22041, US

(21) Appl. No.: 10/813,034

(22) Filed: Mar. 31, 2004

(51) Int. Cl. C05F 11/08

(52) U.S. Cl. 71/8; 435/290.2; 435/290.4

(57) ABSTRACT

A mobile manufacturing equipment and its manufacturing method of organic fertilizer using organic matter including organic wastes of livestock excrements and abattoir wastes, food wastes, night soil, agricultural and fishery wastes, sewage and septic tank sludge. The mobile manufacturing method includes the steps of suction collection of organic matter into mixing reactor by pump; adding additives; introducing vehicle exhaust gas; mixing reactions of hydration, carbonation, desalting reaction and deodorization on the way of transport; sprinkling organic fertilzer to farm land or discharge to a place for processing to dry and granulation.

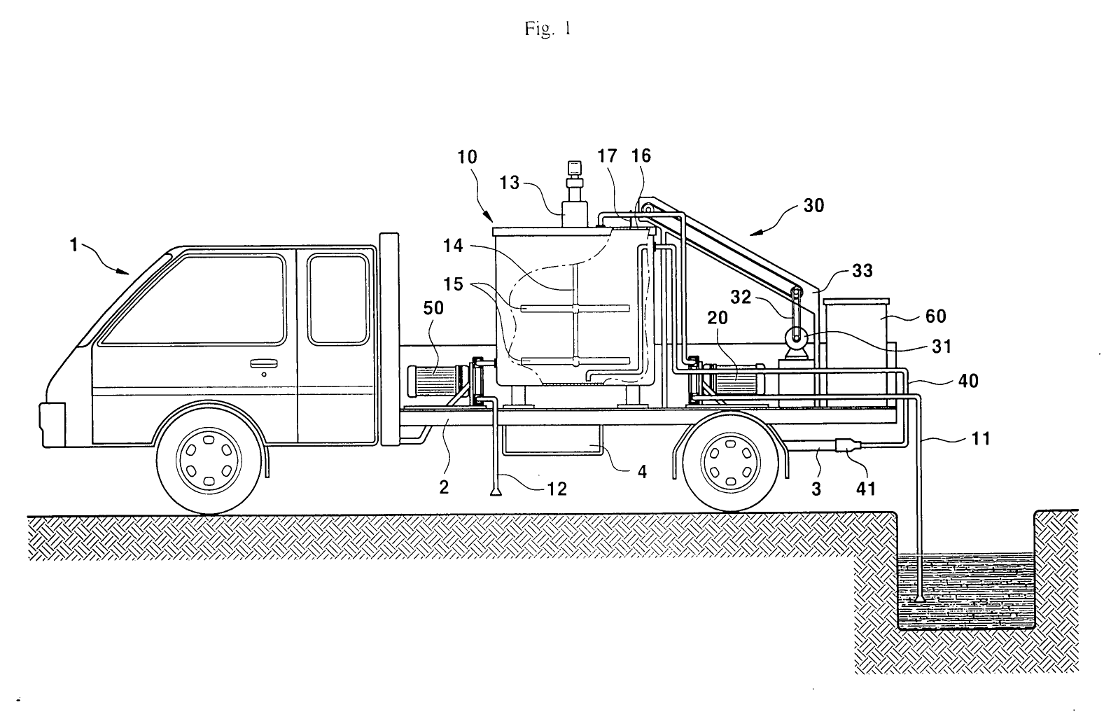

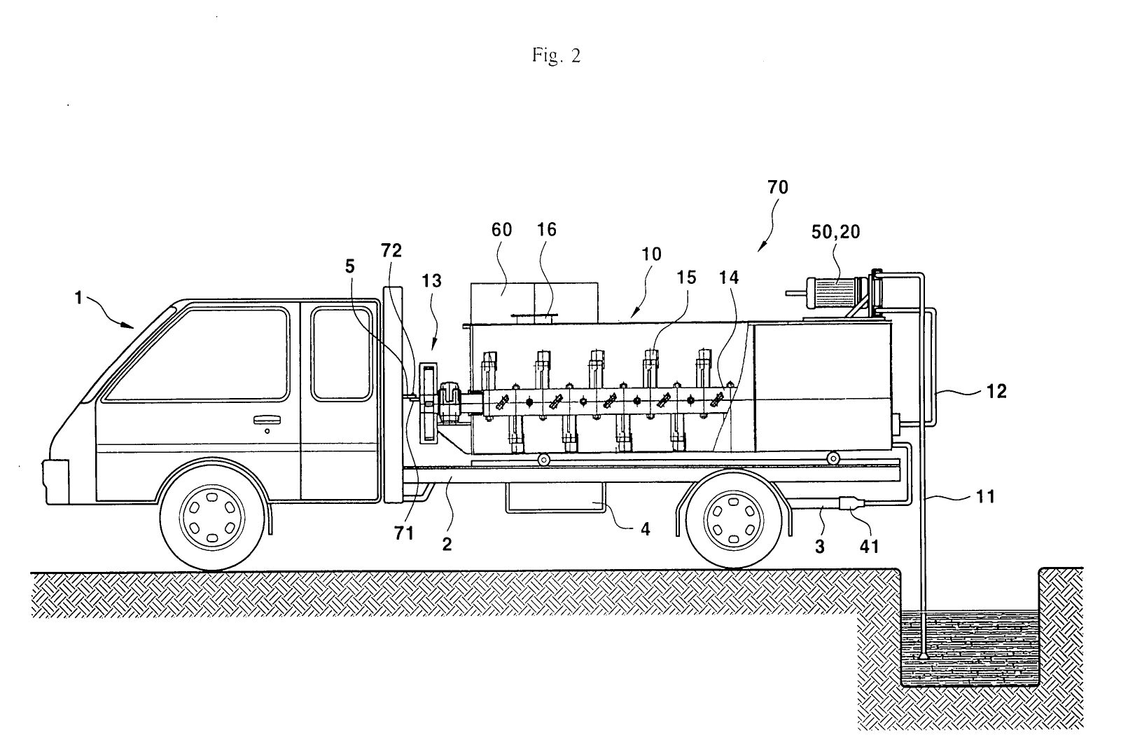

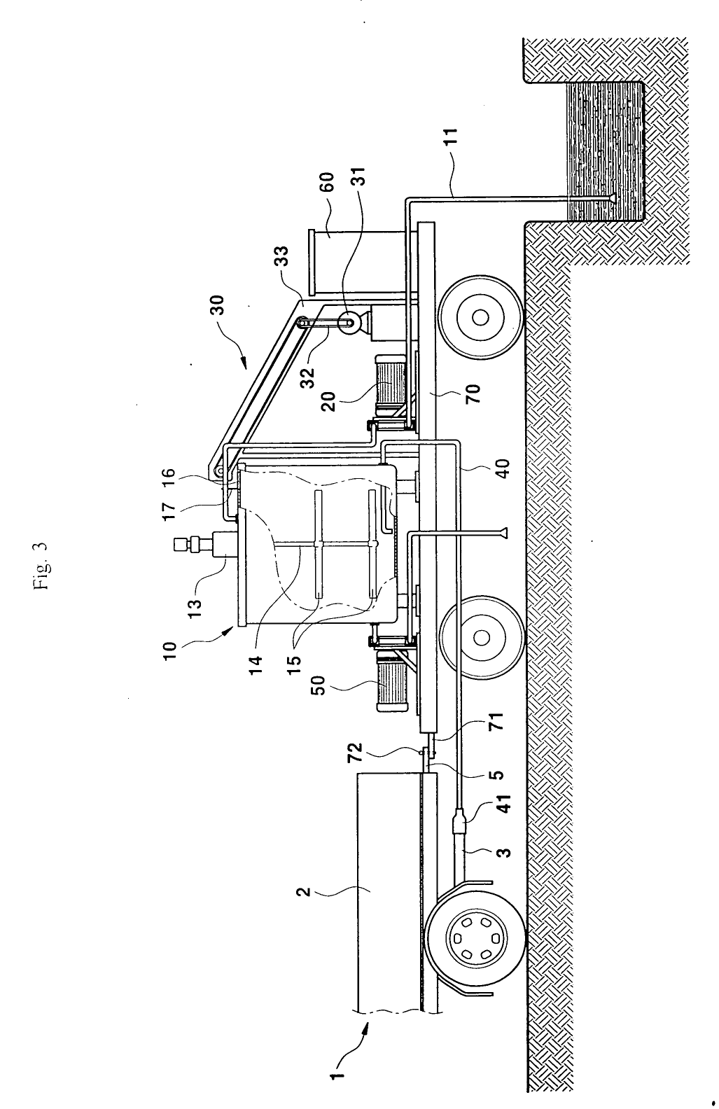

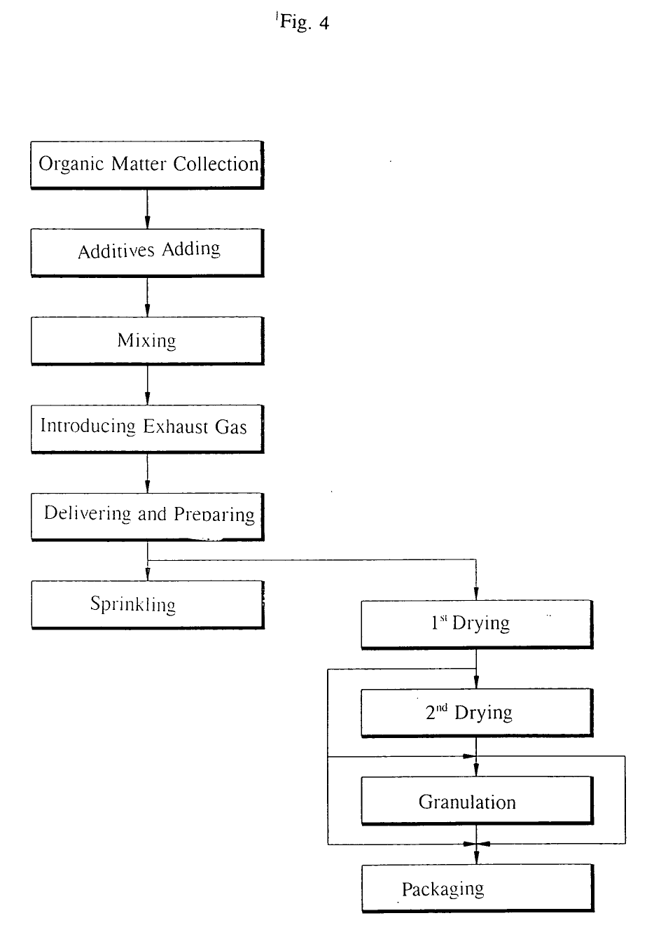

### BACKGROUND OF THE INVENTION

1. Field of the Invention

This invention relates to the mobile manufacturing equipment and its manufacturing method of organic fertilizer utilizing organic matter as a raw material, including organic wastes such as livestock excrements, food wastes, abattoir wastes, sewage and septic tank sludge, agricultural and fishery wastes, animal cadavers, night soil, and other organic matters all of which are rapid putrescible, odorous and visually repulsive and cause a significant source of environmental pollutions.

2. Background of the Related Art

Current treatment of organic wastes mainly relies on land reclamation or cremation and partly on recycling for animal feed and organic fertilizer by application of conventional technologies.

Conventional technologies of recycling from organic wastes to organic fertilizer employ anaerobic and aerobic digestion treatments which require an extended amount of time of 2-3 months for digestion and composting, further the estimation of decomposition is indistinctive and difficult.

Conventional recycling to animal feeds has some unsettled problems of the removal of saline material and mad cow disease for plant-eating animals.

Thus, conventional technologies have their own limitation and problems in practical application.

The latest invention is including applicant's Korean patent No. 0387340 utilize a sound treatment method based upon hydration of quick lime and/or light burnt dolomite which manufactures organic fertilizer from organic wastes at a full scale plant enabling a large volume treatment of organic wastes, and its application is being widely attempted since the treated material is a good organic fertilizer and/or soil conditioner for neutralization of acid soil and supply with deficient nutriments to soil and plants with odor free, visual free and hygienical soundness.

However, this method also has significant problems such as big investment for the construction of a complete manufacturing plant, furthermore it attracts an antagonism from regional citizens and requires various approvals from local and federal authorities, all of which prove to be serious obstacles for practical application. As such all the conventional technologies invented up to date have not entered practical use.

### SUMMARY OF THE INVENTION

The present invention is to provide mobile manufacturing equipment for organic fertilizer and its manufacturing method using organic matter including organic wastes. The object of the present invention is to simplify manufacturing equipment and its process enabling less investment for and low costs in manufacturing of organic fertilizer from organic matter which substantially obviates and solves such unsettled problems of the conventional technologies for practical application.

In attainment of the above purposes, the present invention constitutes mobile manufacturing equipment set up on a carriage vehicle which offers a simple and singular continuous process that is draws in a collection of organic matter by pump into a mixing reactor where mixing reactions occur for manufacturing organic fertilizer during transport to a place of farmland where the product of the organic fertilizer is to be sprinkled by the pump.

For a easy purchase, maintenance, operation and diversion, the present invention is constituted to use ready mixed concrete truck as mobile manufacturing equipment of organic fertilizer.

Further, the present invention is constituted to ensure that the organic fertilizer is of a better quality than the official specifications of organic fertilizer, and to be safe to human body, plants and soils, as well as free from odor and visual repulsion.

Objects, features and technologies of this invention are set forth in part in the following description and in part become apparent to those having ordinary skill in the art upon examination of the following or is learned from practice of this invention. The objectives and other advantages of the invention may be realized and attained by the structure particularly pointed out in the written description, claims and drawings hereof.

The mobile manufacturing equipment and its manufacturing method of the present invention is described making reference to drawings annexed hereto as follows;

Drawing-1 illustrates a truck(1) mounting mobile manufacturing equipment of the present invention, which is found in the loading box(2) of a cargo truck(1). This mobile manufacturing equipment includes the basic characteristics of a technological composition consisting of a suction pump(20) for collection of organic matter into mixing reactor(10) and, a mixing reactor(10) for the mixing reaction of organic matter with additives and, an additive supply device including a belt conveyor(30) with additives stored in the additive box(60) and, a gas induction pipeline for induction of the truck(1) exhaust gas from muffler(3) into the mixing reactor(10) and a discharge pump(50) for the discharge of organic fertilizer made in the mixing reactor(10).

In addition to the above mobile manufacturing equipment, additional facilities of open yard for natural drying, dryer equipment, plastic granulator, storage tanks and shipment equipment are prepared at a certain location.

It is most desirable to use a converter(drawing omitted) for the supply of power to the mixing reactor(10), suction pump(20), belt conveyor(30) and discharge pump(50) in connection with and from battery(4) and engine power of the truck(1), however, a device for electric power supply can be mounted in the loading box of the truck (1) if required.

The mixing reactor mixes and reacts organic matter by the rotation of the agitator impellers(15) mounting both above and below part of the mixer shaft(14) to which power is supplied by the agitator motor(13).

The mixing reactor(10) comprises a suction pipe at one upper part for suction collection of organic matter and, an additive intake(16) at the other upper part for the supply of additives and, a discharge pipe(12) at lower part for the discharge of organic fertilizer all of which are attached with an opening and shutting gate to maintain the inside high temperature and pressure of the mixing reactor in promotion of manufacturing reaction as well as hygienical stabilization. Mixing reactor is operated at a optimum speed of approx. 1-30 rpm, and its type of mechanism is selected among agitating, paddle and screw type reactor in reference to the specific properties of organic matter and work environmental situation.

The present invention uses a ready mixed concrete truck mounting a pump(20/50) for suction and discharge as the most efficient and economical mobile manufacturing equipment whose screw type drum mixer performs high mixing efficiency and provides various advantages of easy purchase, operation, and maintenance because it is ready made truck incorporating its own perfect electric supply device.

The suction pump(20) is installed at the central part of suction pipe(11) and draws in organic matter at a job site into the mixing reactor(10). If organic matter contains wood, rubber iron scrap, plastic, cloths, etc. they are screening out(drawing omitted) or removed by handpicking prior to suction collection. It can be very effective to attach a screen net at the end of intake for screening of alien substances from the organic matter.

To increase the flowability and carbonation efficiency of organic matter in the mixing reactor(10), water content may be adjusted to a range of 60-90% by simply adding water at the time of or before suction.

The conveyor(30) is a feeding device installed in the loading box(2) for the feeding of additives stored in the additive hopper(60) to the mixing reactor(10). The conveyor(30) transports additives into the additive intake(16) of the mixing reactor(10) in a defined amount using the power of the conveyor motor(31) set on the supports(33). This conveyor(30) is a merely exemplary of an additive supply and is not to be construed as a limitation of this invention, instead of which a lifter, hoist, hopper and crane can be used.

The additive is classified into the 1st additive and the 2nd additive, dosages of which are described below; the 1st additive is the additives for the sound treatment of organic matter consisting of quick lime, light burnt dolomite and light burnt magnesite, one of which or a mixture selected among them are fed into the mixing reactor(10) by a feeding device including the conveyor(30) in the amount of 5 to 100 parts by weight based on 100 parts by solid weight of organic material.

The 1st additive is fed into the mixing reactor after the feeding of organic matter. If the 1st additive is to feed prior to the feeding of organic matter, residue water inside mixing reactor(10) should be removed to enable the 1st additive's hydrating reaction is to occur with the water in organic material.

The 2nd additive is additives for the ingredient improving mixture of organic fertilizer which can be fed into mixing reactor with no relevancy to the feeding time of organic matter as the 2nd additive is not a chemically reacting material but a stable mixture.

The 2nd additives comprises of firstly, a siliceous materials of byproduct slag from iron work and wollastonite powder for rice plant farming; secondly, a carbon ingredient of graphite, charcoal and active carbon for growth promotion of plants; thirdly, clay minerals for supply of micronutrient elements; fourthly, zeolite, diatomite and bentonite for improving soil cation exchange capacity; fifthly, sawdust for the adjustment of moisture content; sixthly, nitrogen, phosphate and potassium for the improvement of fertilizer nutrients; seventhly, organic material of farmyard manure, bark, sludge or the like for the supplementary of organic components; and eighthly, other components for customized fertilizer.

The gas pipe(40) is connected between the muffler(3) of truck and the mixing reactor(10) and introduces exhaust gas to the bottom of the mixing reactor(10). The gas pipe(40) is attachable and detachable by the coupler(41). When the truck(1) returns in empty after work, the gas pipe(40) is easily detached.

The discharge pump(50) is installed at the middle part of the discharge pipe and discharges organic fertilizer from the mixing reactor(10) to a farm land or a certain site for processing of drying, granulation, storing and shipment.

If the pump performs both functions of the suction and discharge, then one unit of a pump can be used instead of the suction pump (20) and discharge pump(50). To meet such requirements and simplify the manufacturing equipment, the present invention uses a hose pump, sand pump, mono pump and slurry pump.

For pumping out of organic fertilizer in high solid density and viscosity, a concrete pump car is one of the available pumps.

Drawing No.2 illustrates an other exploded view of a loading trailer type mobile manufacturing equipment of organic fertilizer of the present invention in which additive boxes(60), a pump (20/50) for suction (20) and discharge(50), additive intake chute(16) and mixing reactor(10) are mounted.

For loading on a truck chassis(2), 2 parallel convex-plane tracks of rail shape steel are attached at both under part of the loading trailer(70) and 2 concave tracks of C shape steel are attached on the truck chassis(2) whereon loading trailer(70) travels when loading.

The loading trailer(70) is loaded on the chassis(2) of the truck(1) by trailing along on dual convexo-concave tracks and fixed to the truck(1) by fixing pin(72) thru the hole of the coupled truck link(5) and the vehicle link(71) and is unloaded for stationary collection of organic matter.

The mobile manufacturing method with the loading vehicle manufacturing equipment is the same to that of the truck mounting manufacturing equipment(Drawing No. 1) as aforementioned.

Drawing No. 3 illustrates an exploded view of a pulling trailer type mobile manufacturing equipment of the present invention on which the additive box(60), suction pump(20), conveyor(30), mixing reactor(10) and discharge pump(50) are mounted. The pulling trailer (70) is interlinked to the tractor truck(1) by the fixing pin(72) thru the hole of both the coupled truck link(5) and the vehicle link(71).

The mobile manufacturing method with the pulling trailer manufacturing equipment is the same to that of the truck mounting manufacturing equipment(Drawing No. 1) as aforementioned.

With these mobile manufacturing equipment, organic matter is manufactured to organic fertilizer on the way of transport to a place of destination by hydrating, carbonating, desalting reaction with the 1st additives and by simultaneous mixing with the 2nd additives.

The hydrating reaction of the 1st additives is finished in 5 to 20 minutes that is a stabilization treatment into strong alkaline organic fertilizer and follows carbonating reaction between dissociated OH ion from the 1st additives and CO₂, exhaust gas introduced from the muffler(3) of the truck(1) producing a neutral salt of calcium carbonate which is resulting in dealkalization. Calcium carbonate produced from carbonation takes place drawing the desalting reaction.

In rapid and strong hydrating reaction of the 1st additives, it is recommended to use products of lump sized and very softly burnt. To increase desalting effect, a desalter selected from the group consisting of calcium chloride, calcium carbonate and gypsum material is added into mixing reactor.

Mobile manufacturing method of organic fertilizer from organic matter by the present invention comprises the steps of;

<a>sucking collection of organic matter into mixing reactor(10) illustrated in drawing No. 1-No. 3 or drum mixer of a ready mixed concrete truck by suction pump(20), the step of organic matter collection;

<b>adding 5 to 100 parts by weight of the 1st additives of stabilizer comprising of quick lime, lightly burnt dolomite, lightly burnt magnesite or a mixture of these based on 100 parts of solid weight of organic matter and the 2nd additives of ingredient improver and desalter to mixing reactor(10) or the drum mixer of a ready mixed concrete truck, the step of additive adding;

<C>manufacturing organic fertilizer by mixing reactions with the 1st additives and mixing with the 2nd addittives in the mixing reactor (10) or in the drum mixer of a ready mixed concrete truck, the step of mixing reaction;

<d>introducing the exhaust gas of the truck(1) or the ready mixed concrete truck into the mixing reactor(10) or the drum mixer for the carbonating reaction to dealkalinize, the step of introducing exhaust gas;

<e>discharging dealkalinized organic fertilizer from the mixing reactor(10) or the drum mixer and sprinkling onto farmland, the step of sprinkling organic fertilizer;

<f>processing organic fertilizer discharged by the discharge pump (50) for drying and granulation, etc. the step of processing.

In the step of mixing reaction as described in <c>, organic matter is mixed and reacts via exothermic hydration of the 1st additives generating heat caloric value of 278 kcal per 1 kg-CaO, 254 kcal per 1 kg-light burnt dolomite and 220 kcal per 1 kg-MgO, and dissociate to Ca⁺⁺, Mg⁺⁺ and OH— producing a strong alkaline organic fertilizer in PH value of 11-13.

Such reaction heat and strong alkali kills pathogenic organism and parasites and promotes sound treatment of organic matter. Ca⁺⁺ having a strong combination power reacts with ammonia and sulfate compounds which are the odorous source of putrescent organic matter into calcium compounds resulting in chemical deodorization.

For an increase of the deodorizing effect, active carbon, charcoal, zeolite, diatomite or bentonite as a deodorizer is added to the mixing reactor(10) at the time of additive adding.

External shape of manufactured organic fertilizer is similar particle shape to general soils in brown to dark brown color, thus also eliminating visual disgust.

The content of harmful heavy metals is mainly depending on the components of organic matter which contaminates soils. Harmful metal should be treated prudentially, however, soil itself contains various heavy metals in micro quantity. General organic matter not mixed with industrial wastes also contains various heavy metals in micro quantity.

Harmful metal contents in organic fertilizer manufactured by the present invention from piggery wastes is greatly lower than that of Korean Official Standard specified As<50 ppm, Cd<5 ppm, Hg<2 ppm, Pb<150 ppm, Cr<300 ppm and Cu<500 ppm, and is safe for fertilizer and/or soil conditioner.

Overuse of organic fertilizer in strong alkaline PH value 11-13 after hydration may cause harmful effects to plant, therefore, it is recommended to fertilize at a proper quantity referring to soil acidity.

Overexposure of strong alkali to skin may also cause hypersensitiveness, therefore, it is required to make strong alkaline organic fertilizer to that of weak alkali in securing safety and fertilizing convenience.

To meet above mentioned requirements, the present invention is devised to introduce the carrying truck's(1) exhaust gas containing approx. 13% density of CO₂, from muffler(3) to the bottom of mixing reactor(10) through gas pipe(40) for carbonating reaction. Truck exhaust gas can be introduced by exhaust pressure itself without a blower or compressor.

Exhaust gas is divided and sprayed into minute bubbles by the rotation mixing of the mixing reactor(10) and exhaust pressure, and CO₂ gas reacts carbonation with dissociated ion of the 1st additives producing neutral salt of calcium carbonate resulting in PH value drop down of organic fertilizer from 11-13 upon hydration to 9-10 after carbonating reaction.

Further, dealkalinization of organic fertilizer can be achieved by drying in an open air or rotary dryer. For instance, organic fertilizer made from piggery waste with PH value of 11-12 upon hydration is dropped down to PH value of 8-9 after natural drying in open yard for 2-4 days.

As the organic fertilizer is a weak alkaline, harmful insects of flies and mosquitoes dodges while it gives a good function of propagation and growth of micro organism as organic matter is their feed.

Carbonating reaction is the secondary exothermic reaction generating calorific value of 365 kcal per 1 kg of Ca(OH)₂, and 206 kcal per 1 kg of Mg(OH)₂ which causes hygienical treatment killing pathogenic organism, parasite and coliforms and, calcium carbonate take place desalting reaction.

Thus, the organic fertilizer manufactured by the present invention is weak alkaline, hygienically sound, odor free and visual unrepulsive, desalted and, is one of good organic fertilizer and/or soil conditioner.

Optimal quantity of the 1st additive is ranged to 5 to 100 parts by weight based on the 100 parts of solid weight of organic matter.

As an example for carbonation rate to the 1st additives by carbonating reaction, when optimal additive quantity is set at 30 kg(1000 kg×15%×20%) for 1 ton of organic matter, theoretical dealkalinization rate is as follows;

Ready mixed concrete truck with 6 m³ capacity and average fuel consumption of 1.6 km per 1 liter requires 25 liters (40 km/1.6 km/C) of fuel for one way drive of 40 km distance. The combustion of 25 liters fuel produces 70.59 kg of CO₂ gas(25 liters×0.92 -petroleum conversion coefficient×0.837-carbon producing coefficient×44-CO₂ per 12-C). Hence theoretical carbonation rate to the 1st additives quantity is approx. 50% [(70.59 kg-CO₂×56-CaO/44-CO2)÷(6 m³×15%×20%×1000)].

The mechanism of hydrating, carbonating, desalting, deodorizing reaction and PH value calculation are defined as follows:

1. Hydrating Reaction
1. Calcium Oxide(CaO)
Formula CaO+H₂O→Ca(OH)₂

$$\begin{matrix}Enthalpy Δ H = - 235.70 - ( - 151.80 - 68.32 ) \\ = - 15.58 \\ = 15.58 kcal \text{/} mol / 56.08 \times 1000 \\ = 278 kcal \text{/} kg - CaO\end{matrix}$$
2) Magnesium Oxide(MgO)
Formula MgO+H₂O→Mg(OH)₂

$$\begin{matrix}Enthalpy Δ H = - 221.00 - ( - 143.80 - 68.32 ) \\ = - 8.88 \\ = 8.88 kcal \text{/} mol / 40.32 \times 1000 \\ = 220 kcal \text{/} kg - MgO\end{matrix}$$
3) Light Burnt Dolomite
   Formula CaO.MgO+2H₂O→Ca(OH)₂+Mg(OH)₂
   Enthalpy 278×0.58+220×0.42=254 kcal/kg-dol.

2. Carbonating Reaction
1) Ca(OH)₂
Formula Ca(OH)₂+H₂O+CO₂→Ca⁺⁺+2OH⁻+CO₂+H₂O
→Ca⁺⁺+HCO₃³¹ +OH³¹+H₂O
→Ca⁺⁺+CO₃⁻⁻+2H₂O→CaCO₃+2H₂O

$$\begin{matrix}Enthalpy Δ H = - 228.46 - 68.32 - ( - 235.70 - 68.32 - 94.05 ) \\ = 27.03 kcal \text{/} mol / 74.09 \times 1000 \\ = 365 kcal \text{/} kg - {Ca ( OH )}_{2} \\ = 482 kcal \text{/} kg - CaO\end{matrix}$$
2) Mg(OH)₂
Formula 4Mg(OH)₂+3CO₂→4Mg⁺⁺+8OH⁻+3CO₂
→4Mg⁺⁺+3HCO₃⁻+5OH⁻
→4Mg⁺⁺+3CO₃⁻⁻+2OH⁻+3H₂O
→3MgCO₃₋Mg(OH)₂₋3H₂O

$$\begin{matrix}Enthalpy Δ H = 3 \times - 261.90 - 221.50 + 3 \times - 68.32 + \\ 4 \times 221.00 + 3 \times 94.05 \\ = - 45.51 \\ = 45.51 kcal \text{/} mol / 221.00 \times 1000 \\ = 206 kcal \text{/} kg - M {g ( HO )}_{2} \\ = 298 kcal \text{/} kg - MgO\end{matrix}$$

3. Desalting Reaction
1) Calcium Carbonate (CaCO₃)
   2NaCl+2):+2CaCO₃→2Na⁺+2Cl⁻+2):+2Ca²⁺+2CO₃²⁻
   →):Ca²⁻+):2Na^{-+):CO}₃²⁻+):2Cl⁻+Ca²⁺+CO₃²⁻
   →):Ca²⁻+2Na⁺+CO₃²⁻+Ca²⁺+):CO₃²⁻+2Cl⁻
   →Na₂CO₃+CaCl₂+):Ca²⁺+):CO₃²⁻
2) Gypsum (CaSO₄)
   2CaSO₄+2NaCl+2):→2Ca²⁺+2SO₄²⁻+2Na⁺+2Cl⁻+2):
   →Ca²⁻+):2Na⁺+SO₄²⁻+Ca²⁺+):2Cl⁻+SO₄²⁻
   →):Ca²⁻+2Na⁺+SO₄²⁻+Ca²⁺+):SO₄²⁻+2Cl⁻
   →Na₂SO₄+CaCl₂+):Ca²⁻+):SO₄²⁻

### <Remark>):=Colloid of Organic Matter

4. Deodorizing Reaction
1)2(CH₃SH)+CaO→(CH₃S)₂Ca+H₂O
2)2(R—COOH)+CaO→(R—COO)₂Ca+H₂O
3) Ca(OH)₂+SOx→CaSOx₊₁+H₂O
4) CaCO₃+SOx→CaSOx₊₁+CO₂↑
5) Ca(OH)₂+H₂S→CaS+2H₂O
6) CaCO₃+H₂S→CaS+H₂O+CO₂↑

PH value of organic matter after hydration
Bases: Solid density 20% 200 g-sol.om/kg-om Water content 80% 800 g-H₂O/kg-om
Abbrev: sol=solid, om=organic matter
1) CaO quantity of 20 parts to 200 g-sol.om
   Qg-CaO/(200 g+Qg-CaO)=20%
   Qg=40 g-CaO/0.8=50 g-CaO
2) The rest water quantity after hydration
   Water=800 g(18 g-H₂O×50 hg-CaO/56 g-CaO)=783.93 g
3) Specific heat after hydration(water=1.0 cal/g° C., solid=0.2 cal/g° C.)

$$\begin{matrix}Specific heat = 783.93 g \times 1.0 + ( 1050 - 783.93 g ) \times 0.2 / 1050 g \\ = 837.144 / 1050 \\ = 0.7973 cal \text{/} g ° C . \\ \approx 0.8 cal \text{/} g ° C .\end{matrix}$$
4) Exothermic reaction heat of hydration
   CaO+H₂O→Ca(OH)₂+15.58 kcal/mole→Ca(OH)₂+278 cal/g-4CaO
5) Total exothermic reaction heat
   H=278 cal/g-CaO×50 g-CaO=13,900 cal/50 g-CaO
6) Temperature of hydrated organic matter
   T=25° C.-ambience+13,900 cal/1050 g/0.8 cal/g° C.=41.55° C.
7) Solubility of Ca(OH)₂(0.141 at 40° C., 0.121 at 60° C.)
   D=0.141−[(0.141−0.121)×(41.55−40)/20]=0.1394 g-Ca(OH)₂/100 g
8) Meltage of Ca(OH)₂ in 783.93 grams of water
   M=783.93 g-H₂O×0.1394 g-Ca(OH)₂/100 g-H₂O=1.0928 gCa(OH)₂
9) Dissociated quantity and density of OH
   Formula: Ca(OH)₂→Ca⁺⁺+2OH⁻+3.98 kcal/mole
   Enthalpy: ΔH=−129.74+2×−54.97+235.70=−3.98 kcal/mole
   Dissociated Q'ty=1.0928 g×2 moleOH⁻/74.09 g=2.95×10⁻² mole
   Density of OH⁻=2.95×10⁻² moleOH⁻/783.93×10⁻³/H₂O=0.03763 mole
10) PH=14−[−log(OH⁻)]=14−(−log0.03763)=14−1.4245×12.58

### DETAILED DESCRIPTION OF THE PREFERRED EMBODIMENT

Now, references are made in detail to the preferred embodiment and comparative embodiment of the present invention as follows:

At a pig farm, approximately 8 kg of pig excrements were collected into plastic containier and mixed well, whose water content was 78.04% and PH was 7.02 which is weak alkaline. This pig excrement was dried at 105° C. for 4 hours and 7 samples of dried pig excrements were prepared with 200 grams each in cylindrical plastic containers of 3 litres volume.

### Embodiment 1

3 samples were added city water each 600 cc, 1130 cc and 1800 cc to produce a water contents of 75%. 85% and 90% followed by adding 40 grams of quick lime to each and mixed well for 5 minutes for hydrations subsequent carbonating reaction took place for 40 minutes by introducing CO₂ gas of 13% density(similar CO₂ density to the exhaust gas of ready mixed concrete truck) diluted from pure CO₂ gas to the bottom of sample container thru rubber hose at the speed of 1500 cc per a minute, and then the PH was measured of the samples and the PH values thereon are presented in <table-1>hereto.

### Embodiment 2

3 samples were added city water each 1130 cc to produce a water content of 85% followed by adding quick lime in the quantity of each 20 grams, 40 grams and 60 grams(additive rate of 10%, 20% and 30% by solid weight to dried organic matter) and mixed well for 5 minutes for hydration, subsequent carbonating reaction took place for 60 minutes by introducing CO2 gas as same method as <embodiment 1>, and then measured PH of the samples at 20 minute intervals and the PH values of the 3 samples are presented in <table-2>hereto.

### Embodiment 3

1 sample was added 1130 cc of city water to produce a water content of 85% followed by adding 40 grams of quick lime and 8 grams of salt and mixed well for 5 minutes for hydration. subsequent carbonating reaction took place for 60 minutes by introducing CO₂ gas as same method as <embodiment 1>, and then measured saline content at every 20 minutes thereof and its saline content value is presented in <table-3>hereto.

### Comparative Embodiment 1

The PH values of 3 samples in <Embodiment 1>were measured at the time before carbonating reaction after hydration of quick lime, and the PH values are presented in <table 1>hereto.

### Comparative Embodiment 2

The PH values of 3 samples in <Embodiment 2>were measured at the time before carbonating reaction after hydration of quick lime, and the PH values are presented in <table-2>hereto.

### Comparative Embodiment 3

The PH value of the sample in <Embodiment 3>was measured at the time before carbonating reaction after hydration of quick lime, and the PH value is presented in <table-3>hereto.

TABLE 1
PH values before and after carbonating reaction for 40 minutes added
10% of quick lime by water content.

| | water content | | |
|---|---|---|---|
| | 75% | 85% | 90% |
| before reaction | 12.4 | 12.4 | 12.5 |
| after reaction | 11.2 | 9.7 | 9.5 |

TABLE 2
PH values of 85% water content by adding quantity of quick lime and
by the time of carbonating reaction.

| | additive/water | | |
|---|---|---|---|
| | 10%/20 gr | 20%/40 gr | 30%/60 gr |
| before reaction | 12.3 | 12.5 | 12.8 |
| 20 min. reaction | 12.2 | 12.3 | 12.5 |
| 40 min. reaction | 9.4 | 9.8 | 10.8 |
| 60 min. reaction | 8.8 | 9.2 | 10.3 |

TABLE 3
Saline density of 85% water content adding 40 grams of quick lime by
the time of carbonating reaction.

| | reaction time | | | |
|---|---|---|---|---|
| | before reaction | 20 min. | 40 min. | 60 min. |
| saline density | 4.40% | 3.60% | 2.90% | 2.30% |

The forgoing embodiments are merely exemplary and are not to be construed as limiting the present invention. The present teachings can be readily applied to other type of apparatuses. The description of the present invention is intended to be illustrative, and not to limit the scope of the claims. Many alternatives, modifications, and variations will be apparent to those skilled in the art.

1. Mobile manufacturing equipment of organic fertilizer from organic matter including organic wastes, characterizing the equipment to be installed on loading box of vehicle consisting of:
(a) mixing reactor for mixing and reacting organic matter;
(b) suction pump for suction collection of organic matter into mixing reactor;
(c) supply device for additive supply to mixing reactor;
(d) gas pipe for introduction of vehicle exhaust gas from muffler to mixing reactor;
(e) discharge pump for discharge of organic fertilizer from mixing reactor to outside.

2. Mobile manufacturing equipment of organic fertilizer as claimed in claim 1, wherein the aforementioned vehicle is cargo truck.

3. Mobile manufacturing equipment of organic fertilizer as claimed in claim 1, wherein the aforementioned vehicle is loading trailer.

4. Mobile manufacturing equipment of organic fertilizer as claimed in claim 1, wherein the aforementioned vehicle is pulling trailer.

5. Mobile manufacturing equipment of organic fertilizer as claimed in claim 1, wherein the aforementioned vehicle is ready mixed concrete truck.

6. Mobile manufacturing equipment of organic fertilizer as claimed in claim 1, wherein the aforementioned mixing reactor is drum mixer of ready mixed concrete truck.

7. Mobile manufacturing method of organic fertilizer from organic matter including organic wastes, the method comprising the steps of:
(a) suction collection of organic matter into mixing reactor by suction pump;
(b) additive adding 5 to 100 parts by weight of quick lime, light burnt dolomite, light burnt magnesite or these mixture based on 100 parts by solid weight of organic matter to mixing reactor;
(c) mixing reaction of organic matter and additives in mixing reactor;
(d) dealkalinizing step of carbonating reaction by introducing exhaust gas of vehicle to mixing reactor;
(e) sprinkling step of organic fertilizer dealkalinized in mixing reactor to soils by discharge pump;
(f) processing step of organic fertilizer discharged by discharge pump to dry, granulate.

8. Mobile manufacturing method of organic fertilizer as claimed in claim 7, in the step of (b), adding one or more desalters selected from the group consisting of calcium carbonate, calcium chloride and gypsum material.

9. Mobile manufacturing method of organic fertilizer as claimed in claim 7, in the step of (b), adding one or more ingredient improvers selected from the group consisting of iron work slag, wollastonite powder, clay, zeolite, diatomite, bentonite, sawdust, nitrogen, phosphate, potassium, organic matter.

10. Mobile manufacturing method of organic fertilizer as claimed in claim 7, in the step of (b), adding one or more deodorizers selected from the group consisting of charcoal, active carbon, zeolite, diatomite and bentonite.
